(19) United States
(12) Patent Application Publication
(10) Pub. No.: US 2024/0006173 A1
(43) Pub. Date: Jan. 4, 2024

(54) SWITCHABLE-PATH ION GUIDE

(71) Applicant: Thermo Fisher Scientific (Bremen) GmbH, Bremen (DE)

(72) Inventor: Hamish Stewart, Bremen (DE)

(73) Assignee: Thermo Fisher Scientific (Bremen) GmbH, Bremen (DE)

(21) Appl. No.: 18/343,645

(22) Filed: Jun. 28, 2023

(30) Foreign Application Priority Data
Jun. 29, 2022 (GB) 2209555.8

(51) Int. Cl. H01J 49/06

(52) U.S. Cl. CPC H01J 49/065; H01J 49/067

(57) ABSTRACT

An ion guide with a switchable ion path for a spectrometer includes a first ion transport aperture configured to receive an ion beam. A radio frequency surface comprises a plurality of radio frequency electrodes arranged on a first surface, such that the radio frequency electrodes are parallel. A radio frequency voltage source is configured to apply an alternating radio frequency phase to each radio frequency electrode. A DC potential source is configured to apply a DC gradient across the radio frequency surface. The DC gradient is configured to guide an ion beam via either a first ion path or a second ion path. Ions travelling in the first ion path are directed between the first ion transport aperture and a second ion transport aperture. Ions travelling in the second ion path are directed between the first ion transport aperture and a third ion transport aperture.

### FIELD OF THE DISCLOSURE

The disclosure relates to the field of spectrometry.

### CROSS-REFERENCE TO RELATED APPLICATIONS

This application claims priority from application GB2209555.8, filed Jun. 29, 2022. The entire disclosure of application GB2209555.8 is incorporated herein by reference.

### BACKGROUND

Spectrometers have conventionally incorporated a linear ion path from source to detector. As spectrometers have increased in complexity, some have incorporated multiple analysers or use multiple fragmentation methods running at different rates. In these more complex instruments, it may be advantageous to branch the ion path. A branched ion path may allow the ions to be directed to one of several analysers, or may allow the bypass of a slow section or of an elongated section, or may allow instrument expansion by adding a port. Slow sections, such as ETD fragmentation cells, may obstruct the operation of faster regions such as time-of-flight analysers. Excessively elongated ion paths may allow transmission losses to build up.

Spectrometers with the capability to branch the ion path typically suffer from at least one of limited space charge volume, contamination and a high complexity of mechanical and/or electronic design.

Existing spectrometers direct the ions to one path or another using a range of techniques. For example, one of two possible channels may be blocked to ions by using an RF phase or a constant DC voltage (for example as shown in U.S. Pat. No. 7,829,850B2 and US20190103261A1). Otherwise, a simple DC step may be used to move ions between one channel and another (for example as shown in U.S. Pat. No. 8,581,181 B2), or a pulsed DC travelling wave may be used to direct ions in one of two possible directions requiring complex segmented electrodes (for example as shown in U.S. Pat. No. 9,984,861 B2).

Generally, spectrometers direct ions through one or more channels, which are relatively narrow. A limited volume may result in space charge effects, which expands the ion beam. If the ion beam is expanded to the extent that it impinges on lenses, other electrodes or other elements of the spectrometer, it may contaminate them. Space charge effects may also create mass range limitations, since the low and high mass ions are pushed out of the trapping field first and so the diversity of detected species is limited. If the space charge effects are strong enough, ions may be blocked completely and sensitivity losses may occur.

Furthermore, dielectric surfaces are prone to contamination from ions, neutrals and droplets. Spectrometers are known to use complex designs to keep dielectric surfaces out of line-of-sight of ions and to prevent electrode surfaces from being presented to neutrals or droplets (for example as shown in U.S. Pat. No. 9,536,722B2).

### SUMMARY OF THE DISCLOSURE

Against this background, there is provided an ion guide with a switchable ion path for a spectrometer. The ion guide comprises a first ion transport aperture configured to receive an ion beam. The ion guide further comprises a radio frequency surface comprising a plurality of radio frequency electrodes arranged on a first surface, such that the plurality of radio frequency electrodes are parallel to each other. The ion guide further comprises a radio frequency voltage source configured to apply an alternating radio frequency phase to each of the plurality of radio frequency electrodes. The ion guide further comprises a DC potential source configured to apply a DC gradient across the radio frequency surface, wherein the DC gradient is configured to guide an ion beam via either a first ion path or a second ion path. The ion guide further comprises a second ion transport aperture and a third ion transport aperture. Ions travelling in the first ion path are directed between the first ion transport aperture and the second ion transport aperture and ions travelling in the second ion path are directed between the first ion transport aperture and the third ion transport aperture.

In this way the ions may be trapped within a large volume over the radio frequency surface. The ions may be gently guided by the DC gradient to follow either the first ion path (between the first ion transport aperture and the second ion transport aperture) or the second ion path (between the first ion transport aperture and the third ion transport aperture).

A DC gradient is particularly desirable in systems operating at higher pressures (or lower vacuums) due to the lower mean-free path of the ions. The ions may be stopped in flight by excess collisions with background gas. These ions may then fail to reach the analyser in a timely manner, resulting in losses or in the ions reaching the analyser for the wrong measurement. Ions that linger in the ion guide may create unwanted space charge effects for other ions in flight. A DC gradient may help to ensure that the ions are removed from the ion guide and reach the analyser, reducing transmission losses and transit time losses.

The DC gradient may comprise an orthogonal component and an axial component.

In this way the DC gradient may guide the ion beam to follow either the first ion path or the second ion path using the orthogonal component, and may guide the ion beam from one end of the ion guide to the other using the axial component.

The second ion transport aperture and the third ion transport aperture may be in a first plane and the orthogonal component of the DC gradient may be parallel to the first plane and the axial component of the DC gradient may be parallel to a direction of a shortest distance from the first ion transport aperture to the first plane.

In this way the DC gradient may guide the ion beam to follow either the first ion path or the second ion path using the orthogonal component, and may guide the ion beam from one end of the ion guide to the other (i.e., between the first ion transport aperture and a plane intersecting the second ion transport aperture and the third ion transport aperture) using the axial component.

The radio frequency electrodes may comprise elongated electrode plates arranged such that the plane of each plate is parallel to the plane of the adjacent plate.

Advantageously, the electrode plates may prevent ions from approaching the first surface.

The radio frequency electrodes may be arranged in a grid.

In this way, the radio frequency electrodes may be used to apply a DC gradient or travelling wave in both the axial and orthogonal directions.

The ion guide may comprise a top plate configured to apply a repelling voltage that repels the ion beam towards the radio frequency surface.

In this way the ions may be compressed close to the radio frequency surface.

The top plate may comprise the DC potential source, wherein the DC potential source may be configured to apply the DC gradient to the top plate.

In this way the top plate may be configured to apply the DC gradient.

The top plate may comprise a PCB and a plurality of DC electrodes printed on the PCB.

Advantageously, the DC electrodes may be printed in shapes that allow DC gradients to be applied. If the top plate is configured to apply a repelling voltage and the top plate comprises DC electrodes printed on the PCB, the repelling voltage keeps the ions from approaching the PCB.

The plurality of DC electrodes may be arranged in a grid.

In this way a two-dimensional DC gradient may be applied.

The plurality of DC electrodes may be arranged in a horseshoe configuration, wherein prongs of the horseshoe are adjacent to the second ion transport aperture and the third ion transport aperture.

In this way the shape of the DC electrodes may help define the first ion path and the second ion path.

The plurality of DC electrodes may be connected by resistors.

In this way a DC gradient may be applied.

The DC potential source may comprise a plurality of auxiliary DC electrodes, wherein each auxiliary DC electrode is positioned between radio frequency electrodes.

In this way the radio frequency electrodes and the DC potential source may both be arranged on or adjacent to the first surface.

The plurality of auxiliary DC electrodes may comprise elongated electrode plates and the radio frequency electrodes may comprise elongated electrode plates arranged such that the plane of each plate is parallel to the plane of the adjacent plate, wherein the planes of the plates of the DC electrodes are parallel to the planes of the plates of the adjacent radio frequency electrodes.

In this way the DC electrodes may be mounted between the radio frequency electrodes, and may apply a strong enough DC gradient to reach the centre of the ion guide.

The auxiliary DC electrodes may comprise elongated electrode plates that are wedge-shaped in the plane of the plates.

In this way the DC electrodes may apply a DC gradient.

Each of the plurality of DC electrodes may comprise a peak and a trough in the top of the plate.

In this way the ion beam may be spatially focused as the ions travel along the first ion path or the second ion path.

The radio frequency electrodes may comprise elongated electrode plates arranged such that the plane of each plate is parallel to the plane of the adjacent plate and the first surface may comprise a PCB wherein the auxiliary DC electrodes comprise printed electrodes between the radio frequency electrodes.

In this way the DC electrodes may be printed between the radio frequency electrodes.

The ion guide may comprise a top surface facing the radio frequency surface comprising a plurality of radio frequency electrodes arranged on the top surface; and a plurality of auxiliary DC electrodes, each of the plurality of auxiliary DC electrodes mounted between radio frequency electrodes.

In this way both the first surface and the top surface may comprise electrodes that provide a pseudopotential surface and apply a DC gradient.

The radio frequency electrodes may comprise elongated electrode plates arranged such that the plane of each plate is parallel to the plane of the adjacent plate, wherein each of the radio frequency electrodes may comprise a first indent and a second indent in the top of the radio frequency electrodes, wherein the first indents and second indents coincide with the position of the first ion path and the second ion path and wherein the first indents and second indents increase in depth towards the second ion transport aperture and the third ion transport aperture.

In this way the ion beam may be spatially focused as the ions travel along the first ion path or the second ion path.

The ion guide may further comprise a first side guard positioned on a first side of the radio frequency surface and a second side guard positioned on a second side of the radio frequency surface.

In this way ions, neutrals, droplets and gas may be prevented from leaking out of the sides of the ion guide. The first and second side guards may be configured to prevent material exiting the ion guide via the first side or the second side, and/or to shape the ion cloud.

The first and second side guards may comprise a first wall and a second wall.

In this way ions, neutrals, droplets and gas may be physically prevented from leaking out of the sides of the ion guide.

The first and second side guards may comprise a first guard electrode and a second guard electrode, wherein the first and second guard electrode are configured to receive either a repulsive DC voltage or an attractive DC voltage.

In this way if a repulsive DC voltage is applied the ions may be repelled from the sides of the ion guide to keep the ions within the main volume of the ion guide as they travel between the first ion transport aperture and the second or third ion transport aperture. If an attractive DC voltage is applied, the ion cloud may be pulled towards edges of the radio frequency electrodes, helping to focus the ion beam.

The first surface may be configured to form the first and second side guards.

In this way separate side guards may not be required.

The radio frequency electrodes may be configured to form the first and second side guards.

Advantageously, the radio frequency electrodes may repel the ions away from the sides of the ion guide.

The first surface may be inclined relative to the top plate or top surface, such that the distance between the first surface and the top plate or top surface decreases closer to the second ion transport aperture and the third ion transport aperture.

In this way the ion beam may be spatially focused as the ions travel from the first ion transport aperture to the second or third ion transport aperture.

The ion guide may further comprise a bin opposite to the first ion transport aperture, wherein the bin is configured to receive undeflected components of the ion beam.

In this way neutrals, droplets or other unwanted material may be removed from the ion guide.

### BRIEF DESCRIPTION OF THE DRAWINGS

A specific embodiment of the disclosure will now be described, by way of example only, with reference to the accompanying drawings in which:

FIG. 1 shows a schematic diagram of an ion guide comprising a radio frequency (RF) surface comprising a plurality of RF electrodes comprising elongated electrode plates, according to an embodiment of the present disclosure.

FIG. 2 shows a schematic diagram of RF electrodes of an ion guide, wherein the RF electrodes comprise indents forming a channel, according to an embodiment of the present disclosure.

FIG. 3 shows a schematic diagram of a cross section of an ion guide according to an embodiment of the present disclosure. FIG. 3A shows an RF electrode, a top plate, a first side guard and a second side guard. FIG. 3B shows an RF electrode and a top plate, wherein the RF electrode comprises a first side guard and a second side guard. FIG. 3C shows an RF electrode and a top plate, wherein the RF electrode comprises a first side guard, a second side guard, a first indent and a second indent. FIG. 3D shows an RF electrode, a top plate, a first DC electrode and a second DC electrode, wherein the RF electrode comprises a first side guard and a second side guard.

FIG. 4 shows a schematic diagram of an ion guide according to an embodiment of the present disclosure, wherein the ion guide comprises a radio frequency (RF) surface comprising a plurality of RF electrodes, and a top plate comprising a DC electrode structure.

FIG. 5 shows a schematic diagram of a DC electrode structure according to an embodiment of the present disclosure, wherein the DC electrode structure comprises a grid of printed electrodes.

FIG. 6 shows a schematic diagram of a DC electrode structure according to an embodiment of the present disclosure, wherein the DC electrode structure comprises a horseshoe shape of printed electrodes.

FIG. 7 shows a schematic diagram of an ion guide according to an embodiment of the present disclosure, wherein the ion guide comprises a radio frequency (RF) surface comprising a plurality of RF electrodes, and a plurality of auxiliary DC electrodes mounted between the RF electrodes.

FIG. 8 shows a schematic diagram of an ion guide according to an embodiment of the present disclosure, wherein the ion guide comprises a radio frequency (RF) surface comprising a plurality of RF electrodes, and a plurality of auxiliary DC electrodes mounted between the RF electrodes and wherein the ion guide further comprises a top surface comprising a plurality of RF electrodes and a plurality of auxiliary DC electrodes mounted between the RF electrodes.

FIG. 9 shows a schematic of a cross section of an auxiliary DC electrode according to an embodiment of the present disclosure.

FIG. 10 shows a schematic diagram of an ion guide according to an embodiment of the present disclosure, wherein the ion guide comprises a radio frequency (RF) surface comprising a plurality of RF electrodes, and a plurality of auxiliary DC electrodes printed between the RF electrodes.

FIG. 11 shows a graph of a proportion of applied voltage to an auxiliary DC electrode that reaches the centre of the ion guide plotted against the recession of the auxiliary DC electrode relative to the RF electrodes.

FIG. 12 shows a schematic diagram of a spectrometer incorporating an ion guide according to an embodiment of the present disclosure.

FIG. 13 shows a schematic of a spectrometer incorporating an ion guide according to an embodiment of the present disclosure. FIG. 13A shows an example of a spiral ion mobility analyser (prior art). FIG. 13B shows a schematic of an arrangement that uses an ion guide according to an embodiment of the present disclosure to allow the spiral ion mobility analyser to be bypassed by the ion beam.

FIG. 14 shows an ion guide according to an embodiment of the present disclosure that splits the ion beam such that a proportion of the ion beam exits via the first exit aperture and a proportion of the ion beam exits via the second exit aperture.

FIG. 15 shows an ion guide according to an embodiment of the present disclosure that splits the ion beam such that proportions of the ion beam exits via a plurality of exit apertures.

FIG. 16 shows a simulated trajectory of an ion beam travelling over an RF surface of an ion guide according to an embodiment of the present disclosure.

FIG. 17 shows graphs of a simulated trajectory of an ion beam travelling through an ion guide according to an embodiment of the present disclosure. FIG. 17A shows a top view and FIG. 17B shows a side view.

### DETAILED DESCRIPTION

An ion guide with a switchable ion path is provided for a spectrometer according to an embodiment of the present disclosure. The ion guide comprises a first ion transport aperture configured to receive an ion beam. The ion guide comprises a radio frequency (RF) surface comprising a plurality of radio frequency electrodes arranged on a first surface, such that the plurality of RF electrodes are parallel to each other. The RF surface may also be referred to as a radio frequency carpet. The ion guide further comprises a radio frequency voltage source configured to apply an alternating radio frequency phase to each of the plurality of RF electrodes. The ion guide further comprises a DC potential source configured to apply a DC gradient across the RF surface, wherein the DC gradient is configured to guide an ion beam via either a first ion path or a second ion path. The ion guide further comprises a second ion transport aperture and a third ion transport aperture, wherein ions travelling in the first ion path are directed to the second ion transport aperture and ions travelling in the second ion path are directed to the third ion transport aperture.

In the following, the term “DC potential source” refers to any source of a DC electric potential. A voltage may be applied to the DC potential source to produce the electric potential (or electric field). The voltage may be applied using a DC voltage source. The DC potential source may comprise electrodes, to which the voltage may be applied to produce a DC electric potential. The DC gradient may be applied using the radio frequency electrodes (so that the RF electrodes comprise the DC potential source) by applying a DC voltage gradient to the radio frequency electrodes. Otherwise, the DC gradient may be applied using auxiliary DC electrodes (wherein the auxiliary DC electrodes comprise the DC potential source).

In use, the ion guide may be configured to receive an ion beam via the first ion transport aperture. The DC gradient may be configured to guide the ion beam via either the first ion path or the second ion path, such that the ions of the ion beam exit the ion guide via either the second ion transport aperture or the third ion transport aperture. The DC gradient may be configured to split the ion beam into a first portion and a second portion, and to guide the first portion of the ion beam along the first ion path (such that the first portion exits the ion guide via the second ion transport aperture) and the second portion of the ion beam along the second ion path (such that the second portion exits the ion guide via the third ion transport aperture). Otherwise, the ion guide may be configured to receive an ion beam via the second ion transport aperture and/or the third ion transport aperture. The DC gradient may be configured to guide ions entering the ion guide via the second ion transport aperture along the first ion path such that the ions are directed to the first ion transport aperture and exit the ion guide via the first ion transport aperture. The DC gradient may be configured to guide ions entering the ion guide via the third ion transport aperture along the second ion path such that the ions are directed to the first ion transport aperture and exit the ion guide via the first ion transport aperture.

For conciseness, most of the following description assumes that ion guide is configured to receive the ion beam via the first ion transport aperture, and that the ion beam exits the ion guide via the second ion transport aperture and/or the third ion transport aperture. The first ion transport aperture is referred to as the inlet, the second ion transport aperture is referred to as the first exit aperture and the third ion transport aperture is referred to as the second exit aperture. However, any of the embodiments described herein may be used in both directions (either such that the ion beam travels from the first ion transport aperture to the second ion transport aperture and/or the third ion transport aperture, or in the reverse direction, such that the ion beam or ion beams travel from the second ion transport aperture and/or the third ion transport aperture to the first ion transport aperture).

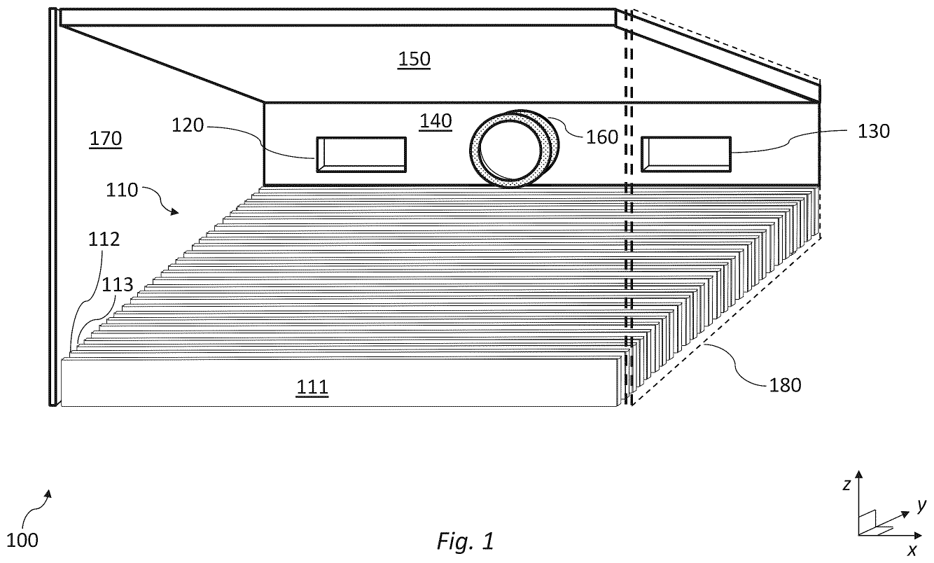

With reference to FIG. 1, an ion guide 100 is shown in accordance with an embodiment of the present disclosure. The ion guide 100 will be described with reference to the axes shown in FIG. 1. The ion guide comprises a front end comprising the first ion transport aperture (inlet) and a back wall 140 comprising the second ion transport aperture (first exit aperture) 120 and the third ion transport aperture (second exit aperture) 130. The front end may be open (such that the first ion transport aperture covers the entire front end) or may comprise a wall comprising the first ion transport aperture.

The RF surface 110 comprises a plurality of RF electrodes arranged to be parallel to one another. In use, opposing radio frequency phases may be applied to alternating RF electrodes in series (such that each RF electrode has an opposing RF phase to its neighbours), creating a repulsive pseudopotential surface. In the embodiment illustrated in FIG. 1, the RF electrodes comprise elongated electrode plates, wherein the planes of each of the plurality of plates are parallel to one another (and to the z-x plane as indicated by the axes in FIG. 1). The first three RF electrodes are labelled as 111, 112 and 113 to illustrate the arrangement. The remaining RF electrodes are not labelled. There may be more or fewer RF electrodes than shown in FIG. 1. In an embodiment, the RF surface 110 may comprise 50 RF electrodes comprising elongated electrode plates. The first surface may be perpendicular to the planes of each of the plurality of plates (and so parallel to the x-y plane) or may be at an angle A to the planes of each of the plurality of plates (so that the first surface is at an angle (90−A)° to the x-y plane). The angle A may, for example, be between 45° and 90°, or may be any other angle.

In another embodiment, the RF surface may comprise a plurality of printed RF electrodes on a PCB. In another embodiment, the RF electrodes may comprise electrodes formed on a substrate, for example by lithography.

In a specific example where the RF electrodes comprise elongated plates, the RF electrodes may comprise a thickness of between 0.5 mm and 1.5 mm and a separation of between 0.5 mm and 1.5 mm. The RF electrodes may comprise other thicknesses or separations. The applied RF voltages may be between 20 and 2000 V with frequencies of between 1 and 3 MHz. the applied RF voltages may have other magnitudes or frequencies. The internal volume of the ion guide may be approximately 100 cm³, wherein the dimensions are approximately 10 cm by 10 cm by 1 cm. However, this is a specific example and the ion guide may have any internal volume. In certain embodiments where the RF electrodes comprise PCB printed electrodes (or electrodes formed on a substrate by means such as lithography), the electrodes may be smaller and more closely spaced than described above. The thickness and spacing of the RF electrodes may be of the order of 10 μm, with an applied RF voltage that may have a frequency of at least 10 MHz. The thickness and spacing of the RF electrodes may be larger than 10 μm, for example between 10 μm and 1 mm.

The ion guide 100 further comprises the first exit aperture 120 and the second exit aperture 130. The ion guide may comprise the back wall 140 comprising the first and second exit apertures 120 and 130. In use, an ion beam may enter the ion guide 100 via an inlet at the front end of the ion guide 100 that is opposite to the back wall (the front end may be open, or may comprise an aperture through which the ion beam enters the ion guide 100). The ions may be guided to either the first exit aperture 120 or the second exit aperture 130 by a DC gradient applied by the DC potential source. The RF surface 110 acts as the ion trapping region, while the DC gradient is superimposed on the RF field to guide ions to a selected exit aperture so that the ions are trapped and guided within a large volume. The DC gradient may comprise a component that guides the ion beam left or right (i.e., in either x direction) to follow the first ion path or the second ion path (referred to as orthogonal DC), but may also comprise a component that accelerates the ions beam from the front end of the ion guide towards the back wall of the ion guide (referred to as axial DC).

The first exit aperture 120 and the second exit aperture 130 may comprise physical apertures to define the maximum extent of the output channel for the ion beam. The first exit aperture 120 and the second exit aperture 130 may comprise physical apertures and may be further defined by electric field(s), so that the first exit aperture 120 and the second exit aperture 130 are defined by physical apertures and by electric fields. The first exit aperture 120 and the second exit aperture 130 may be defined by electric field(s) without a physical aperture. In an embodiment where the first exit aperture 120 and the second exit aperture 130 are defined by electric field(s) without a physical aperture, the back wall may comprise an opening, wherein the opening may extend across all or part of the back wall. The first and second exit apertures 120 and 130 may also have DC voltages applied to them. The DC voltages applied to the first and second exit apertures 120 and 130 may be equal or separate. The DC voltages may be configured to trap or admit ions, for example as required by downstream elements of a spectrometer. The DC voltages may be variable.

The ion guide 100 may further comprise a top plate 150 opposite to the RF surface 110. The top plate 150 may be parallel to the RF surface 110 or at an angle to the RF surface 110. The top plate 150 may be parallel to the x-y plane or at an angle to the x-y plane. The top plate 150 may comprise a ground plate or a repeller plate. In the event that the top plate 150 comprises a repeller plate, the repeller plate may be configured to confine the ion beam close to the RF surface. The repeller plate may comprise a repulsive DC electrode (i.e., a DC electrode to which a DC voltage can be applied to repel the ion beam). The repeller plate may be configured to prevent the ion beam from approaching the repeller plate, avoiding contamination and charging effects on the repeller plate. In an embodiment, the ion beam may be kept at least 5 mm from the repeller plate.

The back wall 140 may optionally further comprise a bin 160. The bin 160 may be positioned between the first exit aperture 120 and the second exit aperture 130. In an event that an ion beam is admitted to the ion guide 100 along with a stream of neutrals and/or charged droplets or other unwanted materials, the bin 160 may be configured to receive the stream of neutrals and/or charged droplets or other unwanted materials. The bin 160 may comprise a cylinder that is open at the ion guide end of the cylinder and closed at the opposing end of the cylinder, so that the bin 160 is configured to receive the unwanted materials, and to retain the unwanted materials in the bin 160. Otherwise, the bin 160 may comprise an aperture or other exit component configured to receive the unwanted materials and allow the unwanted materials to exit the ion guide 100. A pump may be used to aid removal of the unwanted materials from the ion guide via the bin 160.

In certain embodiments, the ion guide 100 may comprise a first side guard and a second side guard. The first and second side guards may be configured to prevent ions from exiting the ion guide 100 via the first (left) side or the second (right) side. The first side and second side each extend between the front end and the back wall 140, and each of the first side and second side may be open, closed, or partially open. The first side and second side may be parallel to one another or at an angle to one another. The first side and second side may be parallel to the z axis. The first side guard and second side guard may comprise first and second guard electrodes respectively. The first and second guard electrodes may be mounted at the first and second sides of the ion guide 100. A small repulsive DC voltage may be applied to the first and second guard electrodes to repel ions from the first side and the second side. The voltage applied to the first and second side guards may be used in combination with the DC gradient to define the maximum sideways displacement of the ion guide. The first and second side guards may comprise first and second guard electrodes or may comprise a series of PCB printed electrodes separated by a resistor chain. The first and second side guards may be physically close the first side and the second side to prevent gas exiting the ion guide 100 via the first side and the second side. In other embodiments, the first side and second side may be open and the first and second side guards may use only electrodes to prevent ions from exiting. In some embodiments, the first and second side guards may be configured to prevent leakages using only physical closures, or using only electrodes, or using a combination of physical closures and electrodes. The embodiment shown in FIG. 1 shows the first and second side guards 170 and 180 as physically closing the first side and the second side.

In some embodiments the ion guide may be configured to increase spatial focusing of the ion beam close to the first exit aperture and the second exit aperture. For example, downstream elements of the spectrometer may have a narrow spatial acceptance so it may be beneficial to focus the ion beam exiting the ion guide. The ion guide may be configured to gradually increase spatial focusing of the ion beam as the ion beam approaches the first or second exit aperture.

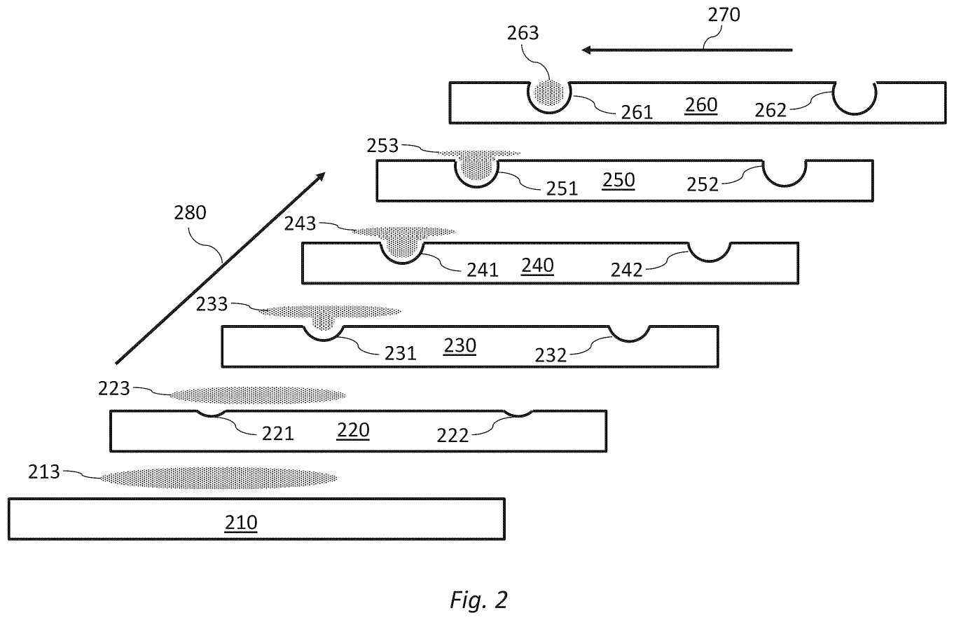

In embodiments where the RF surface comprising RF electrodes comprise elongated electrode plates, the RF electrodes may comprise a channel configured to increase the spatial focusing (i.e., reduce the spatial spread) of the ion beam closer to the first and second exit apertures. With reference to FIG. 2, the RF electrodes may comprise indents that increase in depth nearer to the back wall of the ion guide. For simplicity, only a proportion of the RF electrodes are shown. Of the electrodes shown in FIG. 2, the RF electrode 210 is nearest to the front end of the ion guide and the RF electrode 260 is nearest to the back wall of the ion guide. The front RF electrode 210 comprises an elongated electrode plate with no indent. RF electrodes 220, 230, 240, 250 and 260 each comprise two indents (221, 222, 231, 232, 241, 242, 251, 252, 261, 262) in the top edge of the elongated electrode plate. The indents increase in depth with distance from the front end of the ion guide. The indents may also increase in width with distance from the front end of the ion guide. The indents follow the first ion path and the second path. The DC gradient is configured to guide the ion beam to follow either the first ion path or the second path. In the example shown in FIG. 2, the ion beam follows the left path. The direction of the orthogonal DC that guides the ion beam to the left path is indicated by arrow 270. The direction of the axial DC that accelerates the ion beam towards the back wall is indicated by arrow 280. The ion beam, shown by the dotted areas, passes over the indents of the RF electrodes, and is compressed into the indents by the repelling DC field that confines the ion beam close to the RF surface. The ion beam therefore narrows in focus as it passes over the larger indents and more of the ion beam is accommodated within the indents. The ion beam 213 passing over RF electrode 210 is widest, with a relatively flat cross-section. The ion beam 223 passing over RF electrode 220 is slightly narrower. The ion beam 233 passing over RF electrode 230 is narrower, and a lower portion of the ion beam 233 has started to take on the shape of the indent as the ion beam is compressed into the indent.

The ion beam 233 still retains a wider flatter part above the RF electrode. The ion beams 243 and 253 passing over the RF electrodes 240 and 250 have larger lower proportions that are within the indent, and the upper portion that is wider than the indent reduces in size. The ion beam 263 passing over the RF electrode 260 is narrowest and does not have a part that is wider than the indent. There may be more RF electrodes in between those shown in FIG. 2, such that the increase in size of the indents is gradual. The indents are shown as being arcs of circles, but may be other shapes.

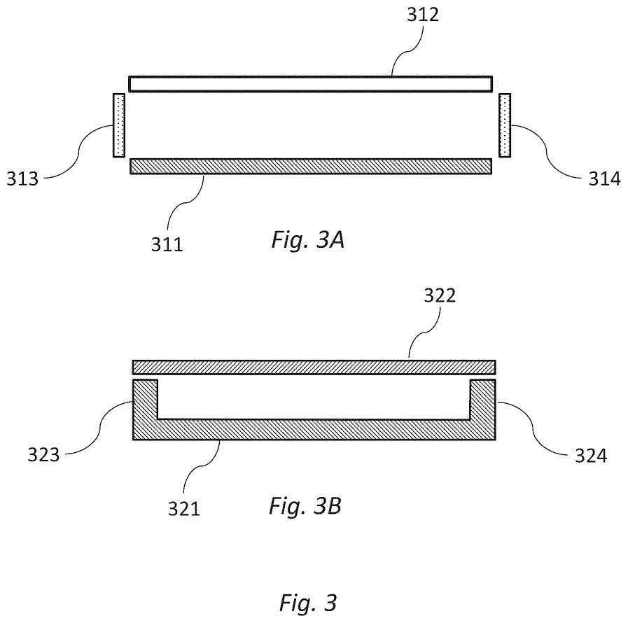

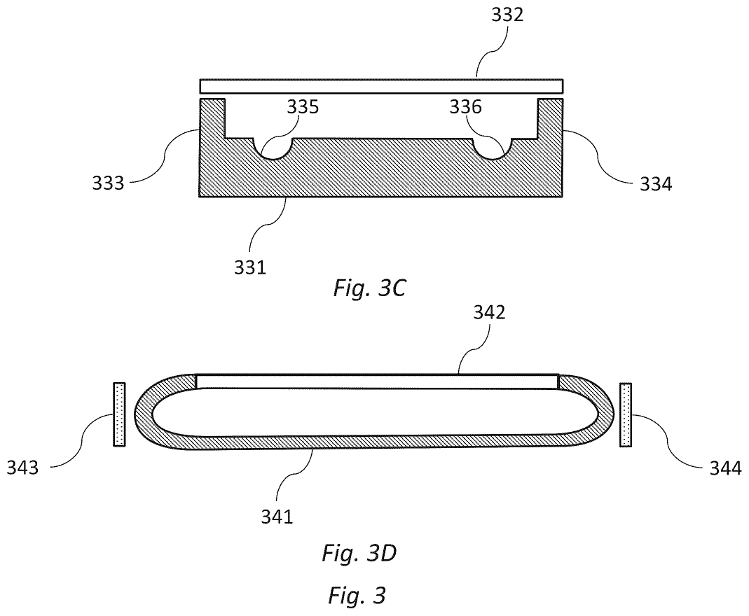

In some embodiments, the RF electrodes may be shaped to provide the first and second side guards, in addition to or instead of being shaped to provide channels. FIG. 3A shows a cross section of an ion guide showing an RF electrode 311 and a DC repeller plate 312. The DC repeller plate 312 may be further configured to apply the DC gradient. The first and second side guards comprise a first DC side guard 313 and a second DC side guard 314. A repulsive DC voltage may be applied to the first and second DC side guards 313 and 314. FIG. 3B shows a cross section of an ion guide showing an RF electrode 321 and a DC repeller plate 322. The RF electrode 321 bends upwards at the ends to form the first side guard 323 and the second side guard 324. The first side guard 323 and the second side guard 324 may be perpendicular to the central portion of the RF electrode 321, at an angle to the central portion of the RF electrode, or the RF electrode may be curved at the ends to form the first and second side guards. FIG. 3C shows a cross-section of a similar configuration to FIG. 3B, where the ends of the RF electrode 331 form the first and second side guards 333 and 334. As in FIG. 3C, the ion guide also comprises a DC repeller plate 332. The RF electrode 331 further comprises a first indent 335 and a second indent 336. The first and second indents 335 and 336 are configured to focus the ion beam as described with reference to FIG. 2. FIG. 3D shows a cross-section of an ion guide comprising a DC repeller plate 342, and an RF electrode 341 that curves at the ends to meet (or approach) the edges of the DC repeller plate 342. The ion guide further comprises attractive DC electrodes 343 and 344. The attractive DC electrodes 343 and 344 may be configured to apply an attractive DC field that pulls the ion cloud towards the edges or corners of the RF electrodes (advantageously, strongly pulling the ion cloud), which improves the focusing of the ion beam,

In certain embodiments, the DC gradient may be applied by applying a DC voltage gradient to the RF electrodes. In other embodiments, the DC gradient may be applied using auxiliary DC electrodes. As will be described in the following, in some embodiments the top plate may comprise auxiliary DC electrodes configured to apply the DC gradient. In other embodiments, the auxiliary DC electrodes may be mounted between the RF electrodes. Both axial and orthogonal components of the DC gradient may be applied using the auxiliary DC electrodes, or both axial and orthogonal components of the DC gradient may be applied using the RF electrodes, or one component may be applied using the auxiliary DC electrodes and the other component may be applied using the RF electrodes.

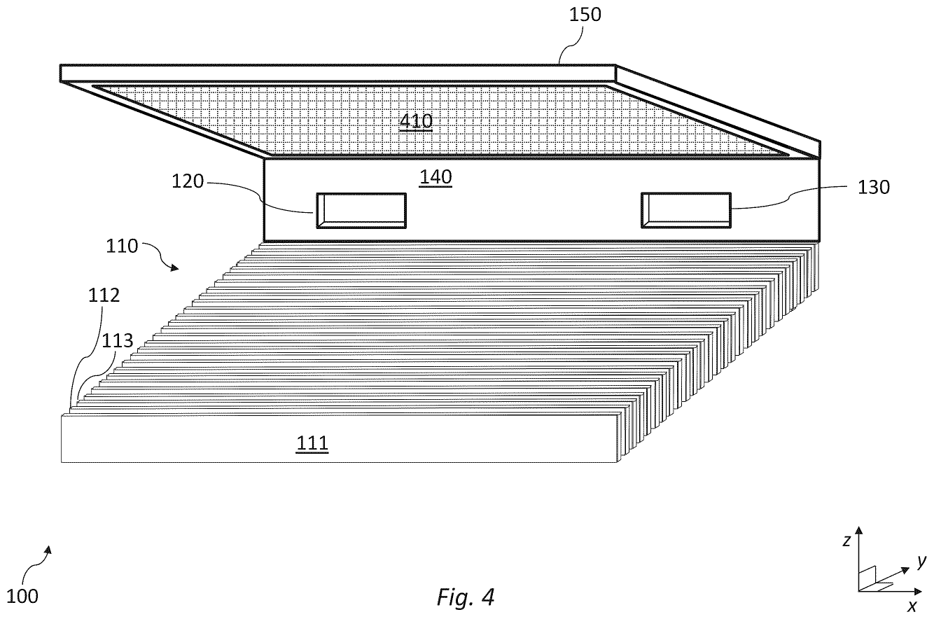

In an embodiment, with reference to FIG. 4, the top plate 150 comprises a repeller plate. In the example shown in FIG. 4, the configuration of the RF surface is the same as in FIG. 1, wherein the RF electrodes comprise elongated electrode plates. As discussed above, the repeller plate may comprise a repulsive DC electrode. The repeller plate may also be configured to apply one or both components of the DC gradient. The repeller plate may comprise a repeller PCB 410 with a printed series of electrodes configured both to act as a repeller and to apply a guiding DC gradient. The DC gradient may be superimposed on the repelling field, such that the ions are guided either to the first exit aperture 120 or to the second exit aperture 130. The DC gradient comprises an orthogonal component and may also comprise an axial component. The orthogonal DC gradient may be configured to provide a guiding force in both orthogonal directions (left and right). Optionally, the DC gradient may be configured to provide a guiding force in one orthogonal direction only (for example pushing ions either to the left or to the right), whilst the other direction may be provided by a DC series (by linking the series of RF electrodes with resistors and applying DC voltages between the electrodes, so that a series of DC steps between the RF electrodes form a gradient), travelling wave or pulsed DC applied to the RF electrodes. The guiding force of the RF electrodes may depend on the direction in which the RF electrodes are mounted. The RF electrodes may be mounted such that the planes of the elongated electrode plates are parallel to the z-x plane. Optionally, the RF electrodes may instead be mounted such that the planes of the elongated electrode plates are parallel to the z-y plane. The RF electrodes may be configured to provide the orthogonal component of the DC gradient, and the top plate may be configured to provide the axial component of the DC gradient. In another embodiment, the RF electrodes may be arranged in a grid comprising rows of electrodes parallel to the z-y plane and columns of electrodes parallel to the z-x plane, such that DC gradients or travelling waves may be applied in both orthogonal and axial directions.

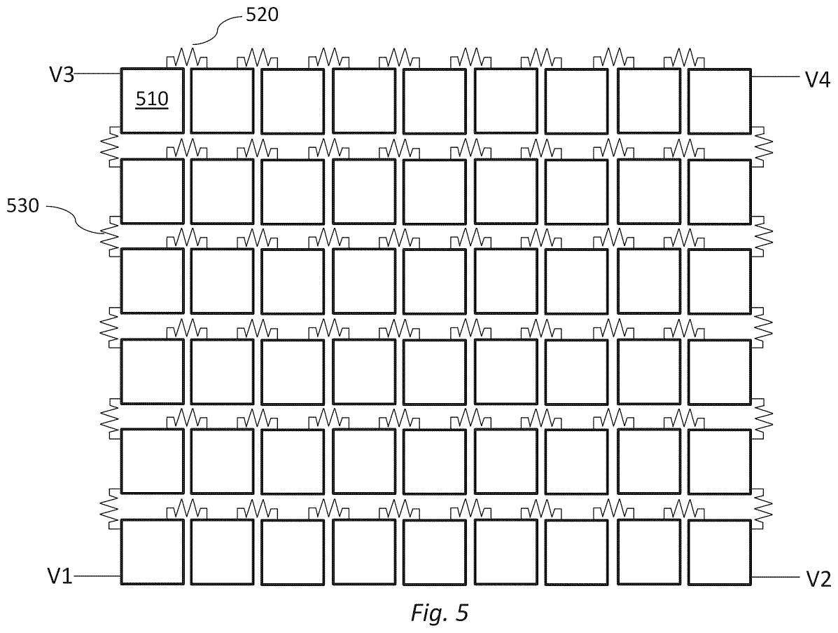

A repeller PCB configured to apply a DC gradient may comprise a series of printed electrodes separated by a resistor chain. A voltage may be applied at each end. A linear DC gradient may be generated by a linear one-dimensional series of electrodes. The ion guide may require a DC gradient in two dimensions, in one dimension to provide the orthogonal DC gradient to guide the ion beam to either the first ion path or the second ion path, and in a second dimension to provide the axial DC gradient to accelerate the ions from the front end of the ion guide to the back wall. With reference to FIG. 5, a diagonal DC gradient may be generated using a grid of printed electrodes separated by resistors.

The electrodes are shown by the squares, for example 510. Each electrode in a row is separated by a resistor (for example 520), and the electrodes on the end of each row are separated from the electrodes at the end of the adjacent row by a resistor (for example 530). A two-dimensional DC gradient requires four voltage inputs, one at each corner of the grid (V1, V2, V3 and V4).

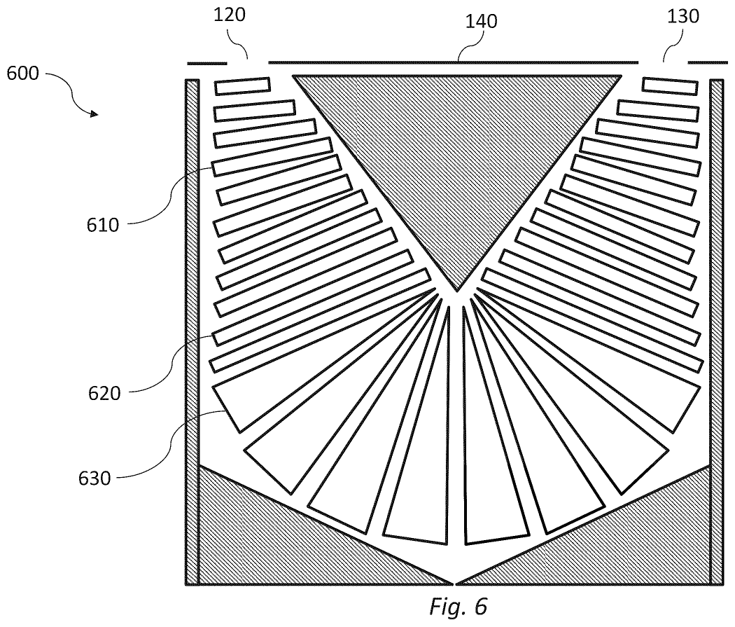

In another embodiment, the top plate 150 may comprise a repeller plate 600 comprising DC electrodes arranged in a shape that defines the first and second ion paths. With reference to FIG. 6, the top plate 150 may comprise a horseshoe-shaped configuration of DC electrodes. The back wall 140 is indicated to show the positions of the first exit aperture 120 and the second exit aperture 130. The bottom of the repeller plate 600 corresponds to the front end of the ion guide. In use, the ion beam enters the ion guide via the front end and the polarity of the DC gradient determines which of the first and second exit apertures 120 and 130 the ion beam is guided to. The DC electrodes may be printed. The DC electrodes are indicated by the white rectangles and triangles (three of the DC electrodes 610, 620 and 630 are labelled in FIG. 6 as examples). The DC electrodes may be segmented differently to form the horseshoe shape. The remaining space around the horseshoe, indicated by hatching, is configured to be repulsive to ions. This may be achieved by the use of DC side guards and/or by other printed electrodes. The width of the channel narrows towards the first and second exit apertures 120 and 130, focusing the ion beam close to the exit apertures and allowing a broad channel near the front end of the ion guide. The repeller plate 600 may be further configured to accept ions that are passed back to the ion guide from downstream elements (for example ion optics) via one of the exit apertures. The ions may be guided to the other exit aperture without altering the DC gradient while the ions are stored within the ion guide.

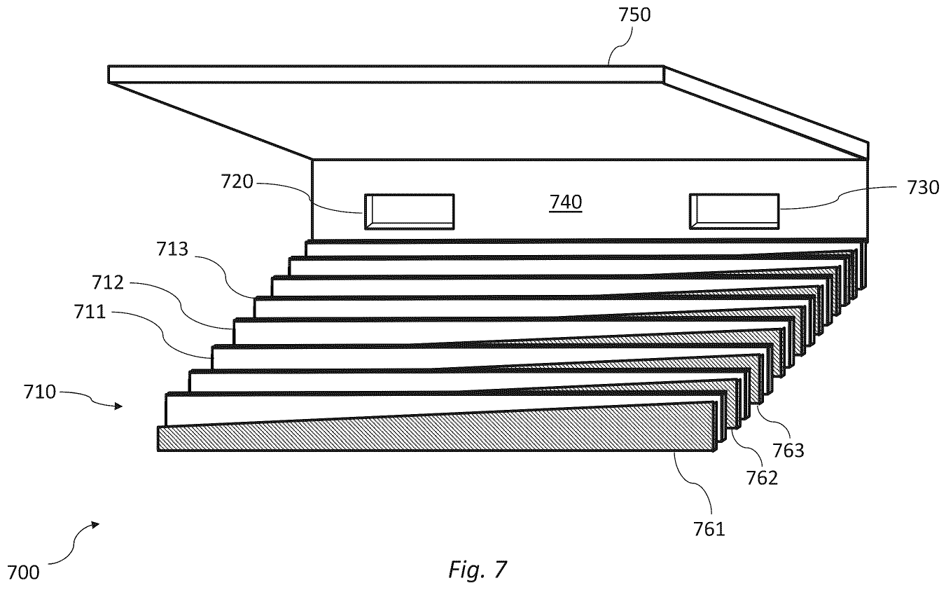

As described above, the top plate 150 may comprise a repeller plate configured to apply the DC gradient in addition the repelling field. With reference to FIG. 7, in an embodiment an ion guide 700 may comprise a top plate 750 that comprises a ground plate or a repeller plate, but does not apply a DC gradient. The ion guide comprises an RF surface 710 similar to that in FIG. 1, wherein RF electrodes comprise elongated electrode plates (three exemplary RF electrodes are labelled as 711, 712 and 713). The ion guide 700 comprises a back wall 740 comprising a first exit aperture 720 and a second exit aperture 730. The ion guide further comprises auxiliary DC electrodes mounted between the RF electrodes, indicated by hatching (three exemplary DC electrodes are labelled as 761, 762 and 763). The static potential felt by the ion beam is a combination of the DC applied to the RF electrodes and the DC applied to the auxiliary DC electrodes. The axial DC gradient may be achieved by varying the height of successive DC electrodes, or by connecting the auxiliary electrodes by a resistor chain. The orthogonal DC gradient may be achieved by having wedge-shaped auxiliary DC electrodes, as shown in FIG. 7.

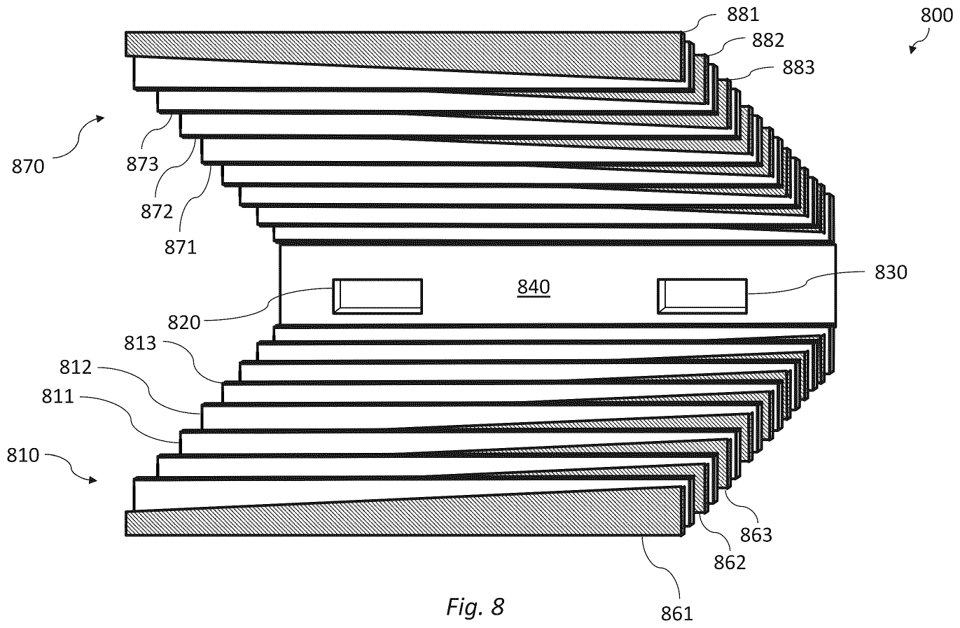

In an embodiment, the top plate 750 shown in FIG. 7 may be replaced by a second RF surface. With reference to FIG. 8, an ion guide 800 comprises a first RF surface 810 that is the same as that shown in FIG. 7. The first RF surface comprises RF electrodes comprising elongated electrode plates (three exemplary RF electrodes are labelled as 811, 812 and 813). The ion guide further comprises auxiliary DC electrodes mounted between the RF electrodes of the first RF surface, indicated by hatching (three exemplary DC electrodes are labelled as 861, 862 and 863). The ion guide 800 comprises a back wall 840 comprising a first exit aperture 820 and a second exit aperture 830. The ion guide 800 comprises a second RF surface 870 at the top of the ion guide. The second RF surface comprises RF electrodes comprising elongated electrode plates (three exemplary RF electrodes are labelled as 871, 872 and 873). The ion guide further comprises auxiliary DC electrodes mounted between the RF electrodes of the second RF surface, indicated by hatching (three exemplary auxiliary DC electrodes are labelled as 881, 882 and 883). The static potential felt by the ion beam is a combination of the DC applied to the RF electrodes of the first and second RF surfaces and the DC applied to the auxiliary DC electrodes mounted between the RF electrodes of the first and second RF surfaces. The axial DC gradient may be achieved by varying the height of successive DC electrodes, or by connecting the auxiliary electrodes by a resistor chain. The orthogonal DC gradient may be achieved by having wedge-shaped auxiliary DC electrodes.

The embodiment shown in FIG. 8 does not comprise a repeller plate, so the ions are not compressed towards either the top or bottom RF surfaces. This arrangement increases the volume available to the ions under space charge. However, as described above it may be beneficial to focus the ion beam near to the exit apertures. In embodiments, this may be achieved by inclining one or both RF surfaces, such that the distance between the first RF surface 810 and the second RF surface 870 decreases closer to the back wall 840. In other embodiments, the DC gradient may be configured to be more strongly attractive for either the auxiliary DC electrodes in the first RF surface or the auxiliary DC electrodes in the second RF surface, pulling the ions towards the surface with the more attractive DC gradient.

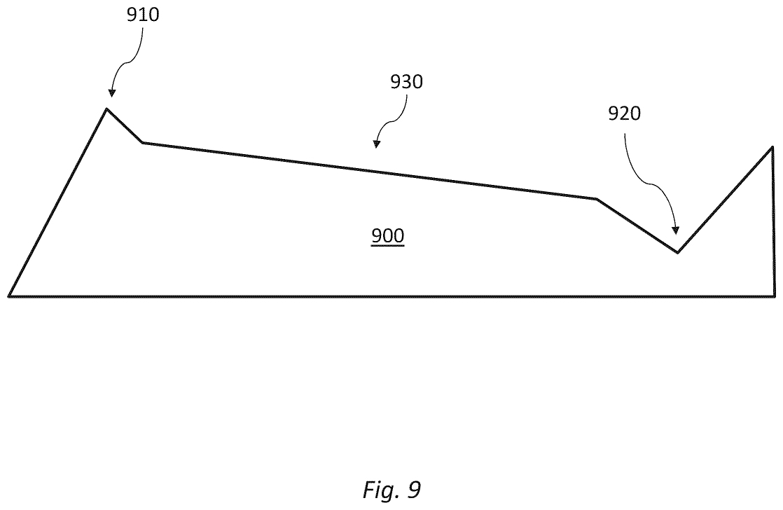

FIGS. 2 and 3C show RF electrodes comprising indents to form a channel in the RF surface. In a similar way, in embodiments where the DC gradient is applied by auxiliary DC electrodes mounted between the RF electrodes, the auxiliary DC electrodes may comprise peaks or troughs to define channels configured to improve spatial focusing of the ion beam close to the exit apertures. This may be in addition to or instead of indents in the RF electrodes. With reference to FIG. 9, an auxiliary DC electrode 900 is shown comprising a peak 910, a trough 920, and a slope 930 between the peak and trough to provide the orthogonal DC gradient. The peak 910 may correspond to the position of the first ion path and the trough 920 may correspond to the position of the second ion path. The ions are guided to either the first or second ion path by choosing the polarity of the DC applied to the auxiliary DC electrode.

It is noted that any of the features described above relating to spatial focusing of the ion beam may be used for spatial focusing of an ion beam travelling from the first ion transport aperture to the second or third ion transport aperture, or for spatial focusing of an ion beam travelling from the second or third ion transport aperture to the first ion transport aperture.

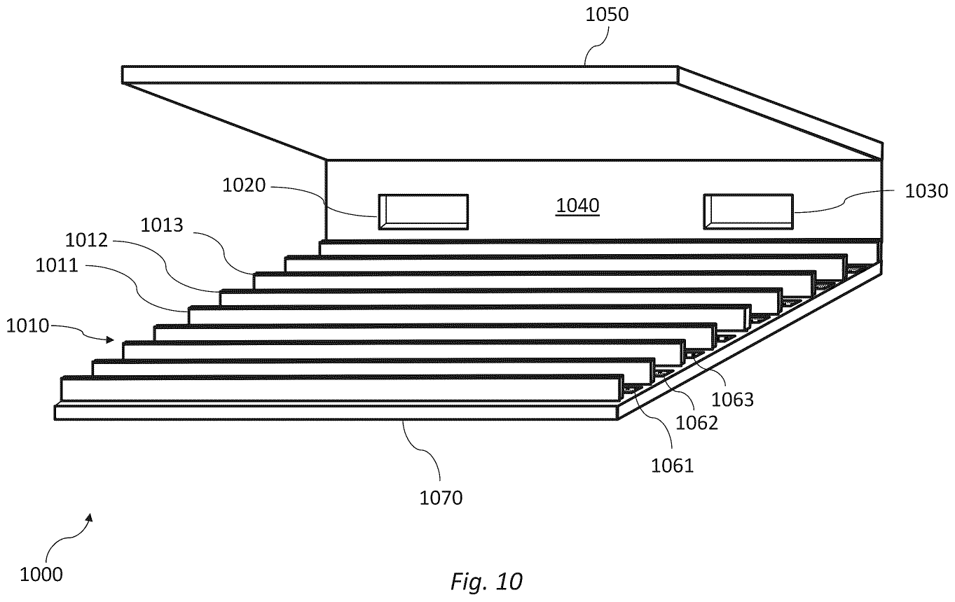

The embodiments described with reference to FIGS. 7 and 8 comprise auxiliary DC electrodes comprising elongated electrode plates. The elongated electrode plates are mounted between the RF electrodes. In other embodiments, the ion guide may comprise auxiliary DC electrodes that are printed between the RF electrodes. With reference to FIG. 10, an ion guide 1000 may comprise an RF surface 1010, a back wall 1040 comprising a first exit aperture 1020 and a second exit aperture 1030, and a top plate 1050. The top plate 1050 may comprise a repeller plate or a ground plate. The ion guide 1000 may further comprise a plurality of auxiliary DC electrodes printed onto a PCB 1070. The RF surface 1010 may comprise RF electrodes mounted between the printed auxiliary DC electrodes. Three RF electrodes 1011, 1012 and 1013 are labelled as examples, and three auxiliary DC electrodes 1061, 1062 and 1063 are labelled as examples. The auxiliary DC electrodes may be separated by resistor chains, for example to form a two-dimensional grid similar to that illustrated in FIG. 5. To reduce contamination, the RF electrodes may overhang the exposed portion of the PCB 1070 between the RF electrodes and the auxiliary DC electrodes (wherein the exposed portion of the PCB 1070 may comprise a dielectric material).

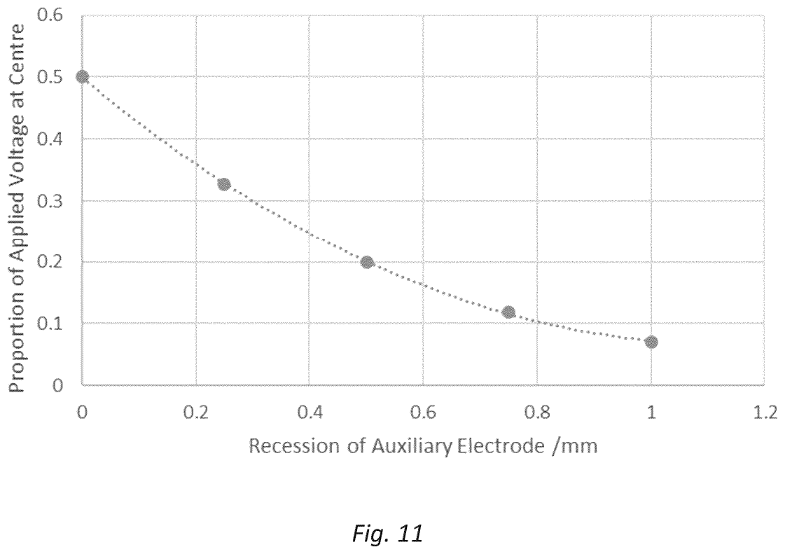

For embodiments comprising auxiliary DC electrodes mounted between the RF electrodes, wherein the auxiliary DC electrodes comprise elongated electrode plates, the heights of the auxiliary DC electrodes relative to the RF electrodes may affect the performance of the ion guide. Preferably, the auxiliary DC electrodes may not protrude above the RF electrodes into the trapping volume of the ion guide. Where auxiliary DC electrodes are recessed below the RF electrodes, the proportion of the applied DC voltage that reaches the centre of the trapping region reduces as the recession of the DC electrodes relative to the RF electrodes increase. FIG. 11 shows a simulation of DC voltage penetration for DC electrodes mounted between RF electrodes with 0.5 mm thickness and inter-electrode spacing. The proportion of applied voltage at the centre is plotted against the recession of the auxiliary DC electrodes relative to the RF electrodes in mm. Other factors to take into account are avoiding the possibility of the creation of small trapping wells between RF and DC electrodes that may impede ion motion through the device, and avoiding the auxiliary DC electrodes working against the RF pseudopotential surface to reduce the mass range of the device.

Various embodiments of the disclosure have been outlined above. The following will discuss several possible applications of the ion guides of this disclosure. The applications described are not limiting, and the ion guide may be used for other applications or in other ways.

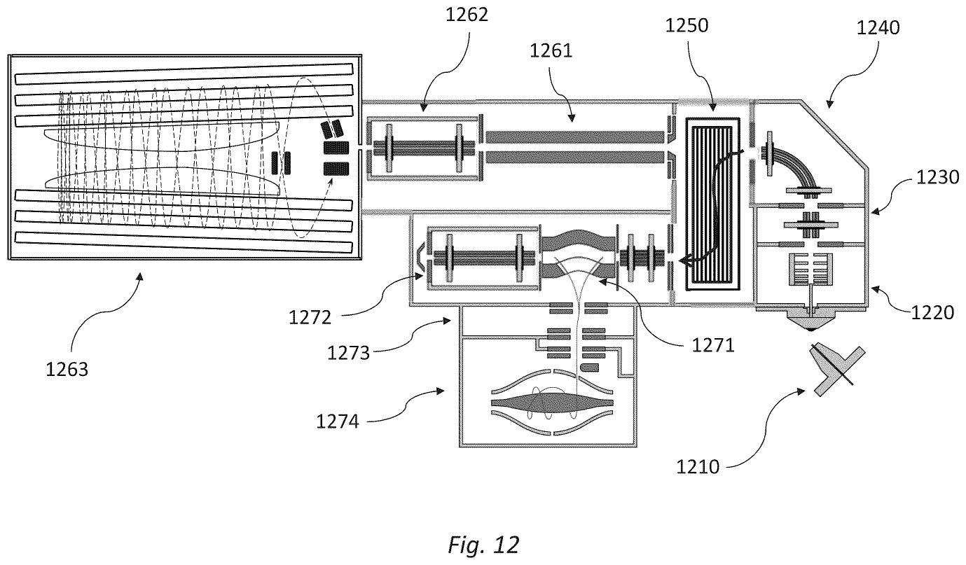

With reference to FIG. 12, an ion guide in accordance with an embodiment of the present disclosure may be used near the front of a complex hybrid mass spectrometer to separate out fast regions from slow or lossy regions. An example is illustrated in FIG. 12, which shows a schematic of an instrument that combines fast MS2 operation through a fast path to a multi-reflection time-of-flight (MR-ToF) analyser 1263 with a slow path to an orbitrap mass analyser 1274 for MS1 or with complex ion processing within an adjacent resolving ion trap (wherein MS1 may comprise analysis of unfragmented precursor ions, and MS2 may comprise analysis of fragmented precursor ions). The instrument may comprise an Electrospray ionization (ESI) source 1210, a lens 1220 (such as an S-lens comprising an ion funnel with increasing interpolate spacing between rings), an ion guide 1230 and a 90° ion guide 1240. The ion beam may then pass through a beam-switching ion guide 1250 according to an embodiment of the present disclosure, and the ion beam may be directed to the fast path or to the slow path. The fast path may comprise a quadrupole mass filter 1261, a collision cell 1262 and the MR-ToF analyser 1263. The slow path may comprise a C-trap 1271, a collision cell or resolving ion trap 1272, an ion guide 1273 and the orbitrap analyser 1274. The ion guides 1230, 1240, and 1273 are not beam-switching ion guides in accordance with this disclosure, and guide the ion beam along a single path. Although it would be possible to arrange the analysers in a single path, ion losses through the chain may reduce the sensitivity of the MR-ToF analyser. The chain would be blocked whenever the ion trap performed slower ion manipulations such as MS3 (involving fragmentation of a fragment ion) or Electron-transfer dissociation (ETD). The MR-ToF analyser also blocks the back of the ion trap, preventing possible mounting of a laser for photodissociation fragmentation. For at least these reasons, the ability to switch between the fast and slow paths is beneficial. Furthermore, the fast and slow paths may be arranged side by side to make the instrument more compact than a single long path.

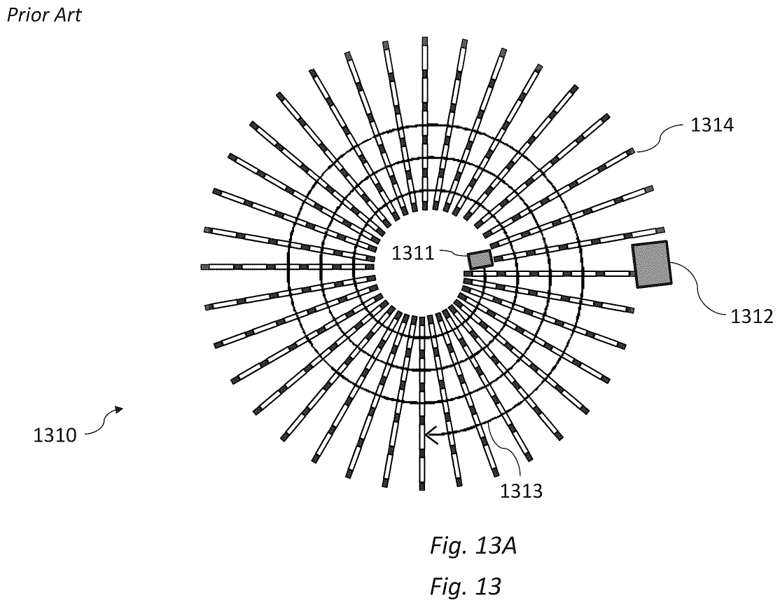

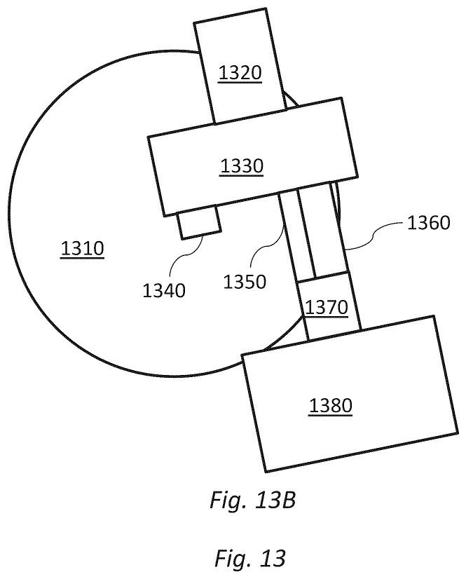

Another application may be to use an ion guide as an optional bypass for very slow regions of a spectrometer. Ion mobility analysis can involve extremely long separation paths, which it may be beneficial to bypass when mobility analysis is not being performed. An example is illustrated in FIG. 13. FIG. 13A shows an example of a spiral ion mobility analyser 1310 (described in US 20200006045 A1). Ions enter the analyser at 1311 and exit the analyser at 1312 having followed a spiral path (illustrated by arrow 1313) though a plurality of multi-aperture electrodes 1314. The spiral path 1313 is extremely long. FIG. 13B shows a schematic of an arrangement that uses a beam-switching ion-guide in accordance with an embodiment of the present disclosure to bypass the spiral ion mobility analyser 1310. The ions enter the beam-switching ion guide 1330 from the ion source 1320. The ions may be guided towards a first (slow) path through the spiral ion mobility analyser 1310, exiting the beam-switching ion guide 1330 and entering the spiral ion mobility analyser 1310 at 1340. Ions exit the spiral ion mobility analyser 1310 via path 1350. Alternatively, the ions may be guided towards a second (fast) path that bypasses the spiral ion mobility analyser 1310, such that the ions exit the beam-switching ion guide 1330 along path 1360. The paths are merged at 1370. The ions then enter the mass analyser 1380. The merging at 1370 may be carried out by a beam-splitting ion-guide in accordance with an embodiment of the present disclosure, where the ions enter the ion-guide via the first and second exit apertures and are merged into one beam.

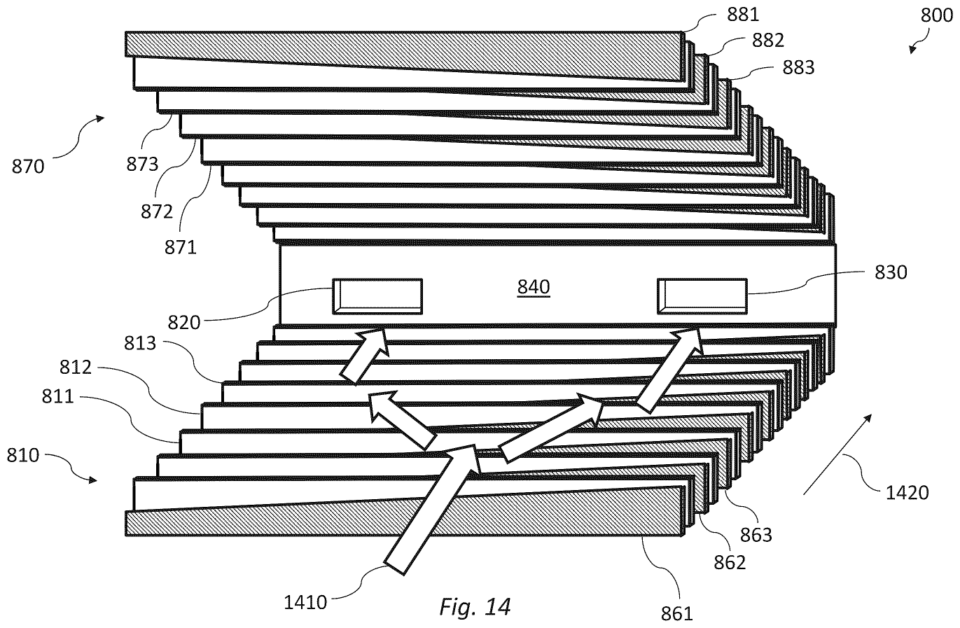

The ion guides of the present disclosure may be used to separate an ion beam of mixed negative and positive ions. With reference to FIG. 14, this is illustrated using the embodiment described with reference to FIG. 8. The labels from FIG. 8 are retained. Arrow 1410 indicates a beam of mixed positive and negative ions admitted by gas force from a source. A travelling wave or gas force (with a direction indicated by arrow 1420) is used to propel ions towards the back wall 840. The different polarity ions separate under the orthogonal DC gradient, in this case generated by the wedged auxiliary DC electrodes. Ions of one polarity exit the ion guide via the first exit aperture 820, and ions of the other polarity exit the ion guide via the second exit aperture 830.

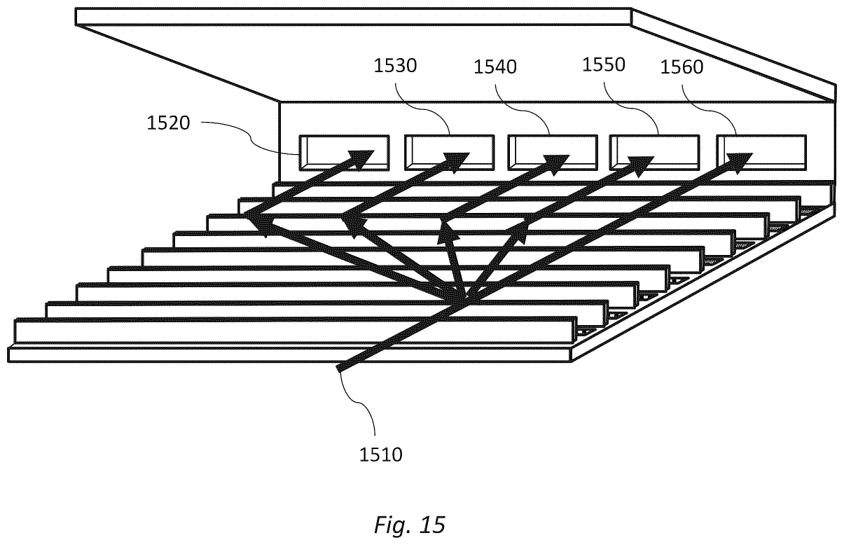

As described above, the ion guides of the present disclosure may be used to direct the entire ion beam through either the first or the second exit aperture. Any of the ion guides described herein may also be used to separate ions across the width of the device based on some property such as polarity, ion mobility or distance of flight (if the DC gradient is pulsed), so that separated ions pass through different apertures for downstream storage, collection or analysis. Furthermore, any of the ion guides described herein may comprise more than two exit apertures. Any of the ion guides described herein may comprise more than one inlet channel. FIG. 15 illustrates an example of an ion guide comprising more than two exit apertures, and that is used to separate an ion beam. The ion guide is the same as that illustrated in FIG. 10, further comprising three additional exit apertures, but the other ion-guides described would work similarly. Injected ions 1510 may be separated into a plurality of beams, as indicated by the arrows, such that the separated beams exit the ion guide via different exit apertures 1520, 1530, 1540, 1550 and 1560.

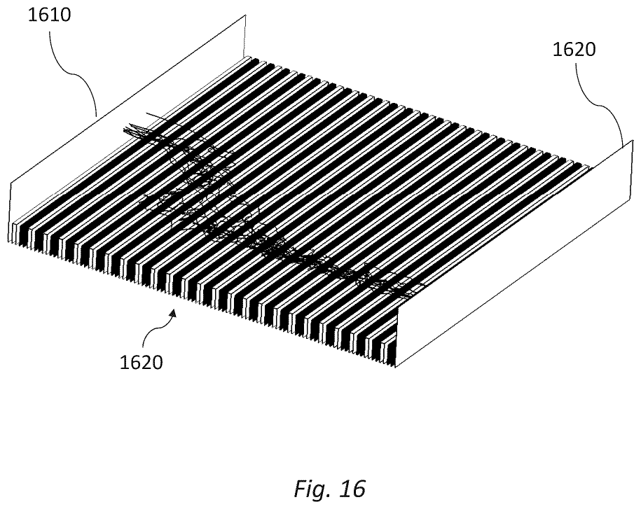

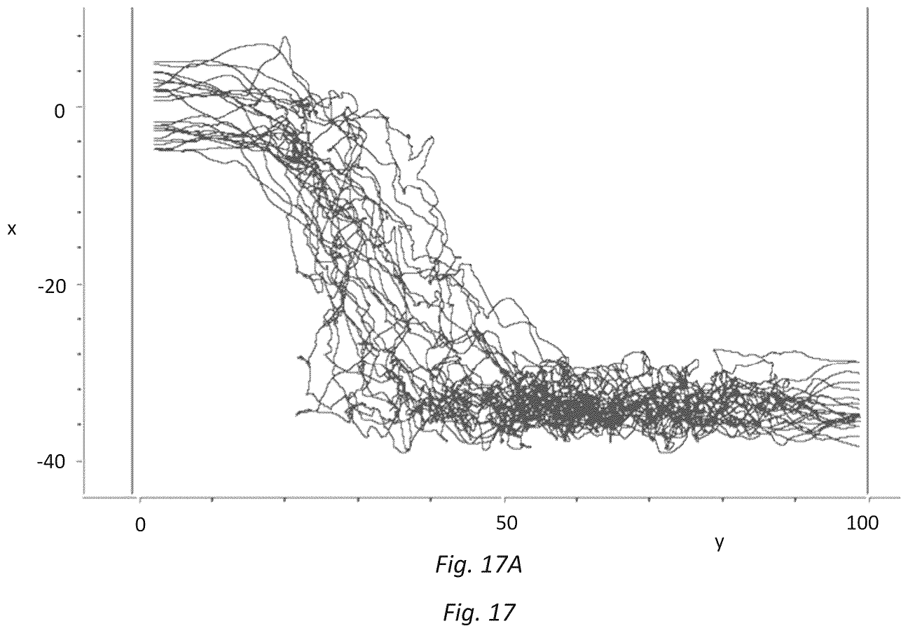

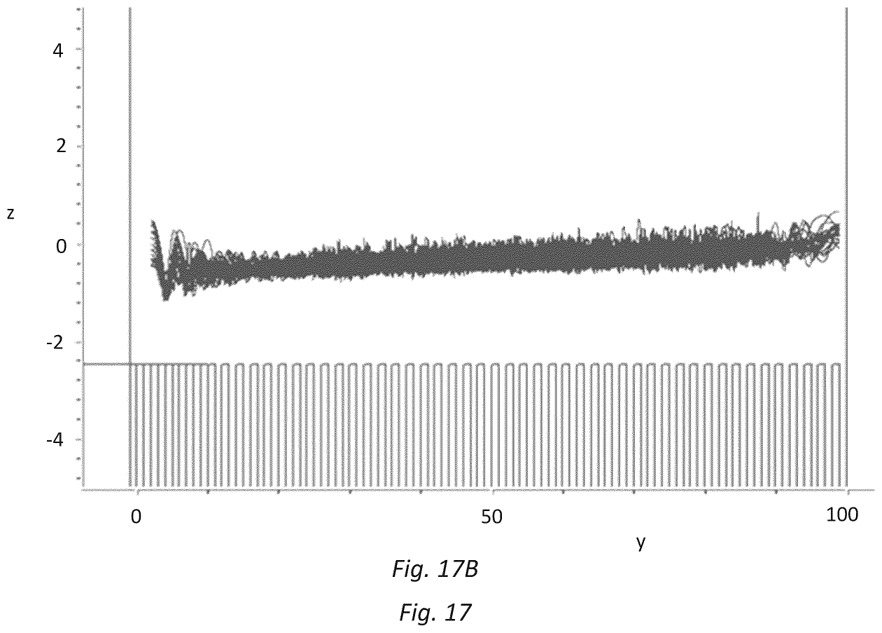

With reference to FIGS. 16 and 17, the trajectories of ions passing through an ion guide have been simulated. The simulations assume an ion guide similar to that illustrated in FIG. 1, wherein the RF electrodes comprise elongated electrode plates with 1 mm thickness and 1 mm inter-electrode spacing. The surface area of the RF surface was 10 cm by 10 cm. The pressure in the ion guide was set to 5×10⁻² mbar (similar to an expected pressure for a region slightly downstream of an ion source). The simulated ion beam entering the ion guide comprised m/z 500 ions with an energy of 1.5 eV, and entered the ion guide 2.5 mm above the RF electrodes (as if entering through a wide aperture). The applied RF was set to 500 V amplitude and 2 MHz frequency. A deflector offset was +15 V, with +12 V applied to the first and second side guard electrodes. The DC gradient across the RF surface was 8 V in the axial direction (along the length of the ion guide) and 5 V in the orthogonal direction (across the width of the ion guide).

FIG. 16 shows the simulated trajectories passing over the RF surface. The front end 1610 and back wall are shown, but the side walls, exit apertures, and the top plate are not shown to avoid obscuring the trajectories. The trajectories are shown as black lines passing over the RF surface 1630 from the front end to the back wall. FIG. 17 shows the trajectories plotted on graphs. FIG. 17A shows the trajectories from above, wherein x is the orthogonal direction (across the width of the RF surface) and y is the axial direction (along the length of the RF surface, from front end to back wall). FIG. 17B shows the trajectories from the side, wherein z is perpendicular to the RF surface and y is the axial direction (along the length of the RF surface, from front end to back wall). The RF electrodes are shown at the bottom of FIG. 17B. It can be seen from FIGS. 16 and 17 that the ions are dragged to one side of the RF surface before the halfway point between the front end and the back wall, and then continue to the back wall with trajectories approximately perpendicular to the back wall (i.e. parallel to and offset from the initial direction of the ion beam entering the ion guide). The ion beam exceeds 5 mm in width when it reaches the back wall, as the embodiment used for the simulations had no spatial focusing of the ion beam. All ions cleared the ion guide within the 3 ms time allotted for the simulation. It is noted that FIG. 17B shows the ions trajectories rising further from the RF surface nearer to the back wall, where the repelling voltage is weakened by the superimposed DC gradient. This may be compensated for by adjusting the repelling voltage, or it may be taken into account when positioning the exit apertures.

Although embodiments according to the disclosure have been described with reference to particular types of devices and applications (particularly mass spectrometers) and the embodiments have particular advantages in such case, as discussed herein, approaches according to the disclosure may be applied to other types of device and/or application. The specific manufacturing details of the ion guide and associated uses, whilst potentially advantageous (especially in view of known manufacturing constraints and capabilities), may be varied significantly to arrive at devices with similar or identical operation. Each feature disclosed in this specification, unless stated otherwise, may be replaced by alternative features serving the same, equivalent or similar purpose. Thus, unless stated otherwise, each feature disclosed is one example only of a generic series of equivalent or similar features.

As used herein, including in the claims, unless the context indicates otherwise, singular forms of the terms herein are to be construed as including the plural form and vice versa. For instance, unless the context indicates otherwise, a singular reference herein including in the claims, such as “a” or “an” (such as an analogue to digital convertor) means “one or more” (for instance, one or more analogue to digital convertor). Throughout the description and claims of this disclosure, the words “comprise”, “including”, “having” and “contain” and variations of the words, for example “comprising” and “comprises” or similar, mean “including but not limited to”, and are not intended to (and do not) exclude other components.

The use of any and all examples, or exemplary language (“for instance”, “such as”, “for example” and like language) provided herein, is intended merely to better illustrate the invention and does not indicate a limitation on the scope of the invention unless otherwise claimed. No language in the specification should be construed as indicating any non-claimed element as essential to the practice of the invention.

Any steps described in this specification may be performed in any order or simultaneously unless stated or the context requires otherwise.

All of the aspects and/or features disclosed in this specification may be combined in any combination, except combinations where at least some of such features and/or steps are mutually exclusive. As described herein, there may be particular combinations of aspects that are of further benefit, such the aspects of ion guides for use in mass spectrometers and/or ion mobility spectrometers. In particular, the preferred features of the invention are applicable to all aspects of the invention and may be used in any combination. Likewise, features described in non-essential combinations may be used separately (not in combination).

1. An ion guide with a switchable ion path for a spectrometer, the ion guide comprising:
a first ion transport aperture configured to receive an ion beam;
a radio frequency surface comprising a plurality of radio frequency electrodes arranged on a first surface, such that the plurality of radio frequency electrodes are parallel to each other;
a radio frequency voltage source configured to apply an alternating radio frequency phase to each of the plurality of radio frequency electrodes;
a DC potential source configured to apply a DC gradient across the radio frequency surface, wherein the DC gradient is configured to guide an ion beam via either a first ion path or a second ion path;
a second ion transport aperture; and
a third ion transport aperture;
wherein ions travelling in the first ion path are directed between the first ion transport aperture and the second ion transport aperture and ions travelling in the second ion path are directed between the first ion transport aperture and the third ion transport aperture.

2. The ion guide of claim 1 wherein the DC gradient comprises an orthogonal component and an axial component.

3. The ion guide of claim 2, wherein the second ion transport aperture and the third ion transport aperture are in a first plane and wherein the orthogonal component of the DC gradient is parallel to the first plane and the axial component of the DC gradient is parallel to a direction of a shortest distance between the first ion transport aperture and the first plane.

4. The ion guide of claim 1 wherein the radio frequency electrodes comprise elongated electrode plates arranged such that the plane of each plate is parallel to the plane of the adjacent plate.

5. The ion guide of claim 1 wherein the radio frequency electrodes are arranged in a grid.

6. The ion guide of claim 1 further comprising a top plate configured to apply a repelling voltage that repels the ion beam towards the radio frequency surface.

7. The ion guide of claim 6 wherein the top plate comprises the DC potential source, wherein the DC potential source is configured to apply the DC gradient to the top plate.

8. The ion guide of claim 7 wherein the top plate comprises a PCB and a plurality of DC electrodes printed on the PCB.

9. The ion guide of claim 8 wherein the plurality of DC electrodes are arranged in a grid.

10. The ion guide of claim 8 wherein the plurality of DC electrodes are arranged in a horseshoe configuration, wherein prongs of the horseshoe are adjacent to the second ion transport aperture and the third ion transport aperture.

11. The ion guide of claim 8 wherein the plurality of DC electrodes are connected by resistors.

12. The ion guide of claim 1 wherein the DC potential source comprises a plurality of auxiliary DC electrodes, wherein each auxiliary DC electrode is positioned between radio frequency electrodes.

13. The ion guide of claim 12 wherein the plurality of auxiliary DC electrodes comprise elongated electrode plates and wherein the radio frequency electrodes comprise elongated electrode plates arranged such that the plane of each plate is parallel to the plane of the adjacent plate, wherein the planes of the plates of the DC electrodes are parallel to the planes of the plates of the adjacent radio frequency electrodes.

14. The ion guide of claim 13 wherein the elongated electrode plates are wedge-shaped in the plane of the plates.

15. The ion guide of claim 13 wherein each of the plurality of DC electrodes comprises a peak and a trough in the top of the plate.

16. The ion guide of claim 12 wherein the radio frequency electrodes comprise elongated electrode plates arranged such that the plane of each plate is parallel to the plane of the adjacent plate and the first surface comprises a PCB, wherein the auxiliary DC electrodes comprise printed electrodes between the radio frequency electrodes.

17. The ion guide of claim 12 wherein the ion guide comprises a top surface facing the radio frequency surface comprising:
a plurality of radio frequency electrodes arranged on the top surface; and
a plurality of auxiliary DC electrodes, each of the plurality of auxiliary DC electrodes mounted between radio frequency electrodes.

18. The ion guide of claim 1 wherein the RF electrodes comprise elongated electrode plates arranged such that the plane of each plate is parallel to the plane of the adjacent plate, and wherein each of the radio frequency electrodes comprise a first indent and a second indent in the top of the radio frequency electrodes, wherein the first indents and second indents coincide with the position of the first ion path and the second ion path and wherein the first indents and second indents increase in depth towards the second ion transport aperture and the third ion transport aperture.

19. The ion guide of claim 1 further comprising a first side guard positioned on a first side of the radio frequency surface and a second side guard positioned on a second side of the radio frequency surface.

20. The ion guide of claim 19 wherein the first and second side guards comprise a first wall and a second wall.

21. The ion guide of claim 19 wherein the first and second side guards comprise a first guard electrode and a second guard electrode, wherein the first and second guard electrode are configured to receive either:
a repulsive DC voltage; or
an attractive DC voltage.

22. The ion guide of claim 19 wherein the first surface is configured to form the first and second side guards.

23. The ion guide of claim 19 wherein the radio frequency electrodes are configured to form the first and second side guards.

24. The ion guide of claim 6 wherein the first surface is inclined relative to the top plate or top surface, such that the distance between the first surface and the top plate or top surface decreases closer to the second ion transport aperture and the third ion transport aperture.

25. The ion guide of claim 1 further comprising a bin opposite to the first ion transport aperture, wherein the bin is configured to receive undeflected components of the ion beam.
